(19) United States
(12) Patent Application Publication
(10) Pub. No.: US 2007/0086057 A1
(43) Pub. Date: Apr. 19, 2007

(54) Method of driving printer

(75) Inventor: Makoto Kanada, Shiojiri-shi (JP)

Correspondence Address: EDWARDS & ANGELL, LLP, P.O. BOX 55874, BOSTON, MA, 02205, US

(73) Assignee: Seiko Epson Corporation, Tokyo (JP)

(21) Appl. No.: 11/542,279

(22) Filed: Oct. 2, 2006

(30) Foreign Application Priority Data
Sep. 30, 2005 (JP) P2005-288727
Dec. 2, 2005 (JP) P2005-349551

(51) Int. Cl. H04N 1/405

(52) U.S. Cl. 358/3.06; 358/1.13

(57) ABSTRACT

When it is activated a printer provided with a print data generator operable to convert inputted image data into print data, and a printing mechanism operable to perform, upon receipt of a print instruction, printing an image with respect to a print medium based on the print data, the print data generator is automatically activated before the print instruction is received.

### BACKGROUND

1. Technical Field

The present invention relates to a method of driving a printer in which a print data generator is initialized based on print setting information.

2. Related Art

A printer can usually perform printing in the size or quality of plural kinds of print medium at plural print qualities (print resolutions).

The user can select the kind of printing medium and the print quality via a user interface (print setting screen) in printing.

The printer is provided with a halftoning processor and a group of lookup tables (plural LUTs corresponding to the kind of print medium and the print quality) for halftoning. Before driving a printing mechanism, the halftoning processor is initialized by referring to the LUT corresponding to the kind of print medium and the print quality selected by the user among the group of LUTs. With this initialization, the halftoning processor can generate data for printing operation (print data corresponding to the kind of print medium and print quality).

However, the CPU used for a printer typically has a lower processing ability than the CPU used for the desk top computer, and requires a lot of time to make initialization for the printing operation. That is, conventionally, since the halftoning processor generates the data for printing operation by referring to the LUT after a print instruction is made by pressing a print start button, it takes a lot of time to start the operation of a printing mechanism by making the print-instruction. Since there is no motion for a while, the user is irritated. Further, since the time required from the print start instruction till the print completion (paper ejection) for the first page is longer than the time required from the paper ejection of the previous page till the print completion (paper ejection) for the second and ensuing pages, the user feels less comfortable to use the printer.

### SUMMARY

It is therefore an advantage of some aspects of the invention to provide a method of driving a printer, in which the time required from a print instruction to the start of driving the printing mechanism is shortened.

According to one aspect of the invention, there is provided a method of driving a printer which comprises a print data generator operable to convert inputted image data into print data, and a printing mechanism operable to perform, upon receipt of a print instruction, printing an image with respect to a print medium based on the print data, the method comprising:

activating the printer; and

initializing the print data generator automatically, before the print instruction is received.

According to one aspect of the invention, there is also provided a method of driving a printer which comprises a print data generator operable to convert inputted image data into print data, and a printing mechanism operable to perform, upon receipt of a print instruction, printing an image with respect to a print medium based on the print data, the method comprising:

displaying a print setting screen adapted to update a condition of the printing therethrough;

updating the condition through the print setting screen;

counting a prescribed time period when the setting is performed; and

initializing the print data generator based on the updated condition when the prescribed time period is counted.

According to one aspect of the invention, there is also provided a method of driving a printer which comprises a print data generator operable to convert inputted image data into print data, and a printing mechanism operable to perform, upon receipt of a print instruction, printing an image with respect to a print medium based on the print data, the method comprising:

displaying a first screen adapted to input the print instruction therethrough;

displaying a second screen adapted to update a condition of the printing therethrough, and having a lower hierarchy than the first screen;

updating the condition through the print setting screen;

detecting a transition from the second screen to the first screen after the updating is performed; and

initializing the print data generator based on the updated condition when the transition is detected.

### BRIEF DESCRIPTION OF THE DRAWINGS

The invention will be described with reference to the accompanying drawings, wherein like numbers reference like elements.

FIG. 1 is a block diagram showing a printer according to a first embodiment of the invention.

FIG. 2A is a flowchart showing an initialization performed when the printer of FIG. 1 is activated.

FIG. 2B is a flowchart showing an initialization performed when a related-art printer is activated.

FIG. 3 is a flowchart showing a print processing executed by the printer of FIG. 1.

FIG. 4 is a block diagram showing a printer according to a second embodiment of the invention.

FIG. 5 is a diagram showing a print instruction screen and a print setting screen used with the printer of FIG. 4.

FIG. 6 is a flowchart showing a print processing executed by the printer of FIG. 4.

FIG. 7 is a block diagram showing a printer according to a third embodiment of the invention.

FIG. 8 is a flowchart showing a print processing executed by the printer of FIG. 7.

FIG. 9 is a block diagram showing a printer according to a fourth embodiment of the invention.

FIG. 10 is a flowchart showing a print processing executed by the printer of FIG. 9.

### DESCRIPTION OF EXEMPLARY EMBODIMENTS

Embodiments of the invention will be described below in detail with reference to the accompanying drawings.

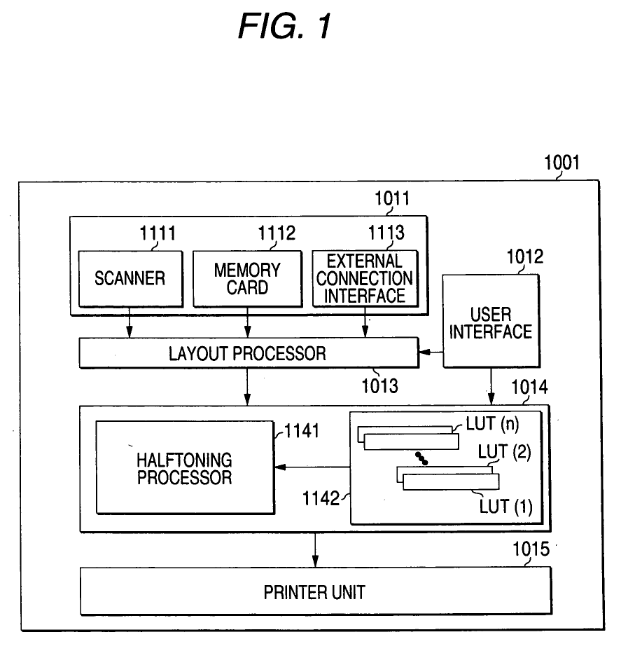

FIG. 1 shows a printer 1001 according to a first embodiment of the invention. The printer 1001 comprises an input device group 1011, a user interface 1012, a layout processor 1013, a halftoning device 1014 and a printer unit 1015.

The input device group 1011 is composed of a plurality of devices, including a scanner 1111, a memory card 1112 and an external connection interface 1113 in this embodiment.

The user interface 1012 may acquire setting instruction information concerning the input device group 1011, print medium (paper kind) and/or print quality (resolution) from the operations of the user. The user interface 1012 has a print start button, and stores the default setting values of the input device group 1011, the print medium (paper kind) and the print quality (resolution).

The layout processor 1013 can receive the select instruction information of the input device (any one of the scanner 1111, the memory card 1112 and the external connection interface 1113) and the setting instruction information of the print medium and the print quality from the user interface 1012.

The halftoning device 1014 comprises a halftoning processor (print data generator) 1141 and a lookup table group 1142. The halftoning processor 1141 can convert an image acquired via the input device group 1011 into the print data by referring to the lookup table group 1142. The lookup table group 1142 is composed of a plurality of lookup tables (LUT(1) to LUT(n)) corresponding to the print medium and/or print quality.

The printer unit 1015 can acquire the print data from the halftoning processor 1141 and print it.

The printer 1001 automatically initializes the input device group 1011, the user interface 1012, the printer unit 1015 and the halftoning device 1014 before starting the printing, when the power is turned on.

In initializing the halftoning device 1014, the halftoning processor 1141 selects a lookup table corresponding to the default setting values of the print medium and the print quality from among the lookup tables (LUT(1) to LUT(n)). The default setting values may be preset or set lastly by the user.

In the normal use of the printer 1001, the setting values of the print medium and the print quality are not frequently changed. In the printer 1001, the halftoning device 1014 is automatically initialized based on the default setting values of the print medium and the print quality, before the user presses the print start button, after the power is turned on. In making the automatic initialization, the input device used by the user who uses the printer 1001 at the previous time or the setting values of the printing media or print quality are regarded as the default setting values for the initialization, whereby there is no inconvenience that it takes a long time since the print start button is pressed till the printing is started, unless the user changes those setting values.

Next, a processing flow of the printer 1001 will be described below. A driving method for the printer according to one embodiment of the invention and the driving method for a related-art printer will be described below at the same time.

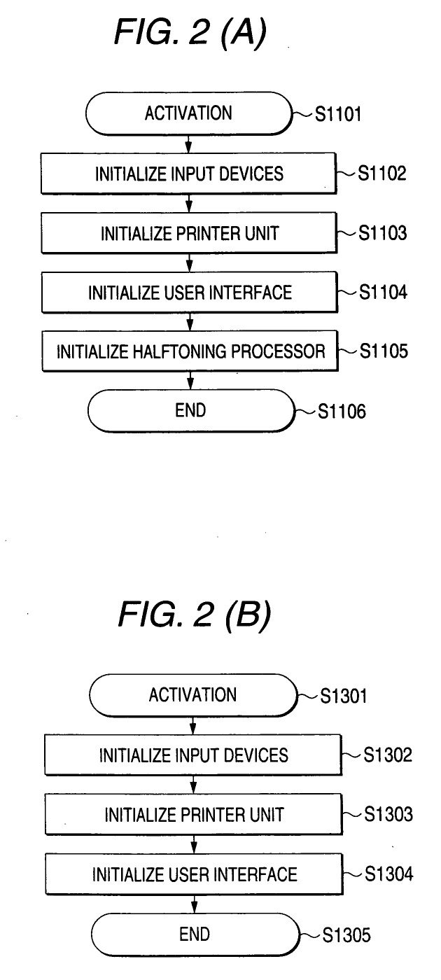

As shown in FIG. 2A, when the printer 1001 is activated (S1101), the input device group 1011 is initialized (S1102), the printer unit 1015 is initialized (S1103), and the user interface 1012 is initialized (S1104). Further, the halftoning device 1014 is initialized (S1105), whereby the automatic initialization processing at the time of activation is finished (S1106).

In initializing the input device group 1011, the printer unit 1015, the user interface 1012 and the halftoning device 1014, the setting values of the print medium and/or print quality may be stored as the fixed values (setting values considered to be most frequently used by the user) in a non-volatile memory (EEPROM), and adopted as the default values. The fixed values can be preset during the manufacture or at the shipment from the factory of the printer 1001. Also, the user may change the fixed values. In this case, in making the first printing processing after the user activates the printer 1001, it is unnecessary to initialize the halftoning device 1014 after starting the printing processing, if the setting values of the print medium and/or print quality are the same as the fixed values.

Also, the last setting values employed at the previous time may be stored in the non-volatile memory and adopted as the default values. In this case, in making the first printing processing after the user activates the printer 1001, it is unnecessary to initialize the halftoning device 1014 after starting the printing processing, if the setting values of the print medium and/or print quality are the same as the last setting values.

As shown in FIG. 2B, when the related-art printer is activated (S1301), the input device group 1011 is initialized (S1302), the printer unit 1015 is initialized (S1303), and the user interface is initialized (S1304) in the same way as the printer 1001 of FIG. 2A, but the halftoning device 1014 is not initialized, whereby the automatic initialization processing at the time of activation is finished (S1306).

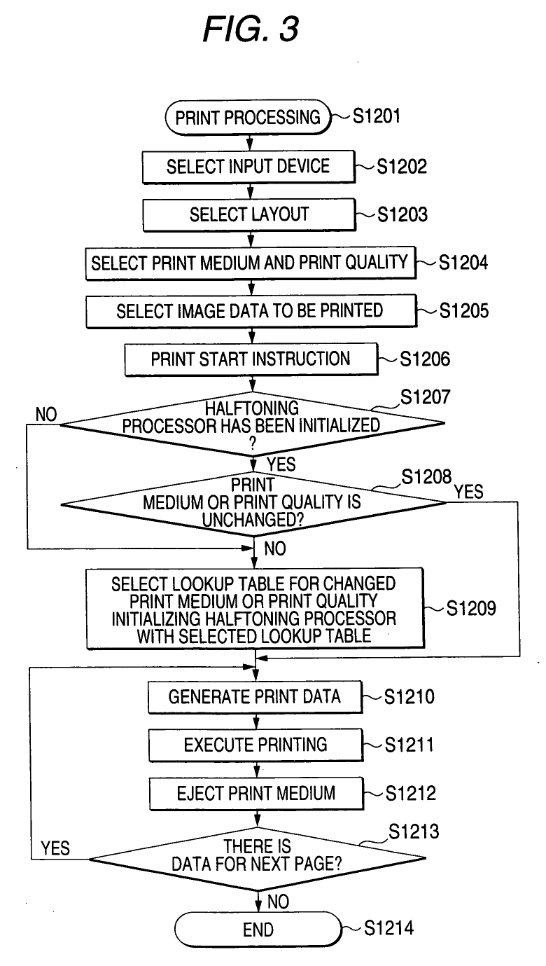

As shown in FIG. 3, after the automatic initialization processing at the time of activation is finished, the user selects the start of printing processing from the user interface 1012 (S1201), and selects any one of the scanner 1111, the memory card 1112 and the external connection interface 1113 from the input device group 1011 (S1202). Then, the user selects the layout such as magnification and arrangement (S1203), selects the print medium and the print quality (S1204), and selects the print object image data (S1205). Thereafter, the user makes a print start instruction by pressing the print start button (S1206).

Thereby, the printer unit 1015 starts the printing processing. The printer unit 1015 judges whether or not the initialization of the halftoning device 1014 is finished (whether or not the initialization of the halftoning device 1014 is newly required) (S1207). When the initialization is not finished, for example, when the input device (any one of the scanner 1111, the memory card 1112 and the external connection interface 1113) is changed (“No” at S1207), the LUT (k) (k=1 to n) corresponding to the print medium and/or print quality is selected from the lookup table group 1142, and the halftoning device 1014 is initialized by referring to the selected LUT (S1209).

When the initialization is finished at S1207, for example, when the input device (any one of the scanner 1111, the memory card 1112 and the external connection interface 1113) is not changed (“Yes” at S1207), it is judged whether or not the print medium and the print quality are the same as the settings in the printing processing at the previous time (S1208). If they are the same (“Yes” at S1208), the print data generation is performed (S1210) without performing an initialization processing for the halftoning device 1014. That is, in a case where the setting value in the print instruction is identical with the default value used in the automatic initialization processing shown in FIG. 2A, or in a case where the setting value in the print instruction is identical with the value which is lastly effected by the user before the latest deactivation and is used in the automatic initialization processing, the determination in S1208 is made as “Yes” and a further initialization processing is omitted. When the printing processing is started after the automatic initialization processing at the time of activation is finished (S1106), it is considered that the initialization is finished at S1207.

In the normal use of the printer 1001, since the setting values of the print medium and/or print quality are not frequently changed, the print medium and the print quality are mostly the same as the settings in the printing processing at the previous time. Accordingly, the initialization of the halftoning device 1014 at S1209 is seldom performed.

Further, in a case where a plurality of print jobs are executed after the activation, and the setting value used in a current print job is identical with the setting value used in an immediate previous job, the determination in S1208 is made as “Yes” and a further initialization processing is omitted.

If the print medium and the print quality are different from those of the printing processing at the previous time at S1208 (“No” at S1208), the processing is passed to S1209 to perform the initialization of the halftoning device 1014 at S1209.

After the print data generation at S1210 is finished, the printing operation is performed (S1211), and the print medium ejection is performed (S1212).

Thereafter, it is judged whether or not there is the next page in the printing processing (S1213). If there is the next page (“Yes” at S1213), the processing is returned to S1210. If there is not the next page (“No” at S1213), the processing is finished (S1214). When the other printing processing (print job) is performed without deactivating the printer 1001, the processing is started from S1201. However, as described the above, in a case where the setting value used in a current print job is identical with the setting value used in an immediate previous job, a further initialization processing may be omitted.

The default setting values of the print medium and the print quality can be set for each of the input devices 1011. In this case, the halftoning processor 1141 selects, in the automatic initialization, the lookup table LUT(k) corresponding to the default setting values of the print medium and the print quality of the input device that becomes effective firstly after the activation of the printer 1001.

Next, a second embodiment of the invention will be described. In this embodiment, when the print medium type A or print quality B is set on the print setting screen, the halftoning processor (print data generator) is initialized if a predetermined time passes after the setting time.

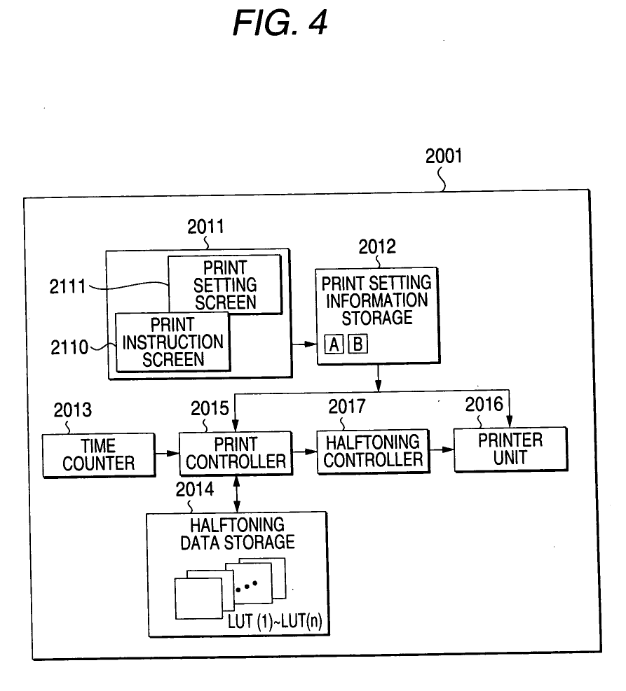

As shown in FIG. 4, a printer 2001 comprises a display 2011, a print setting information storage 2012, a time counter 2013, a halftoning data storage (print data generation table storage) 2014, a print controller 2015, a printer unit 2016 (printing mechanism), and a halftoning processor (print data generator) 2017.

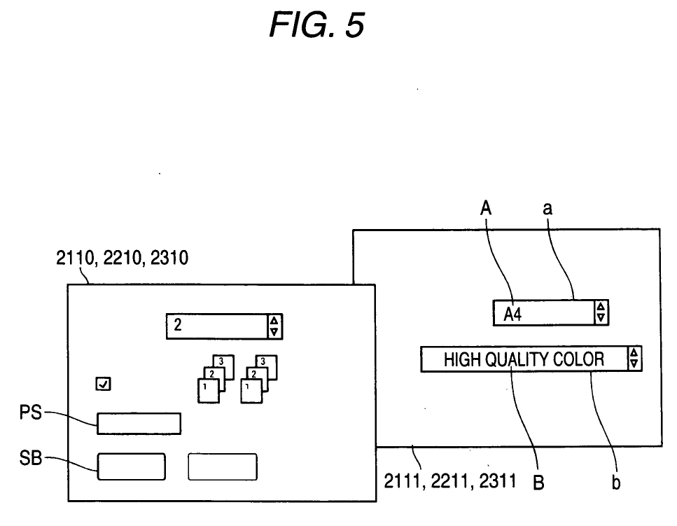

In the display 2011, a print setting screen 2111 including the text boxes or the like for a plurality of print setting information. In this embodiment, the print setting information is print medium type A and print quality B, and the print setting screen 2111 contains the text boxes a, b for them, as shown in FIG. 5. In this specification, the “print setting information” is information which changes the initializing condition of the halftoning processor 2017, if the setting is changed. In this embodiment, the initializing condition is the setting of print medium type A or print quality B.

An initial screen of the display 2011 is a print instruction screen 2110 as shown in FIG. 5, and a print setting screen 2111 exists at its lower hierarchy. By pressing a print setting button PS on the print instruction screen 2110 (indicated as the “print setting” in FIG. 5), the screen display is changed to the print setting screen 2111.

Though a print start button SB (indicated as the “print start” in FIG. 5) is displayed on the print instruction screen 2110, the print instruction screen 2110 and the print setting screen 2111 may be integrated on the same screen in this embodiment. That is, in this embodiment, the halftoning processor 2017 is initialized, irrespective of the hierarchical structure of an display 2011, whereby even if the print start button SB and the text boxes a, b are displayed on the same screen, the action of this embodiment is not affected. In this embodiment, the print start button SB is a software button, but may be a hardware button (not shown) provided in the printer 2001.

The print setting information storage 2012 stores the print medium type A and the print quality B at the previous initialization of the halftoning processor 2017. In this embodiment, the initializing condition information of the halftoning processor 2017 is the print medium type A and the print quality B used at the previous initialization of the halftoning processor 2017, as previously described, but may be the information (e.g., table ID) specifying a print data generation table used at the previous initialization of the halftoning processor 2017.

The time counter 2013 counts a predetermined time period elapsed from the setting time, if at least one of the print medium type A and the print quality B is set on the print setting screen 2111.

The halftoning data storage 2014 stores a group of lookup tables (LUT(1) to LUT(n): halftoning data) corresponding to a plurality of print medium types A and a plurality of print qualities B.

The print controller 2015 performs the following processing, when the count value of the time counter 2013 indicates the elapse of the predetermined time, if at least one of the print medium type A and the print quality B is set on the print setting screen 2111.

That is, the initialization of the halftoning processor 2017 is already performed, and it is determined whether or not the print medium type A and the print quality B that are newly set are identical to the print medium type A and the print quality B used at the previous initialization of the halftoning processor 2017, in which if identical, the initialization of the halftoning processor 2017 is not performed, or if not identical, the initialization of the halftoning processor 2017 is performed.

This initialization is performed based on the lookup table corresponding to the latest print medium type A and/or print quality B. That is, the print controller 2015 initializes the halftoning processor 2017 by referring to the lookup table corresponding to the setting values of the print medium type A and print quality B from the group of lookup tables (LUT(1) to LUT(n)). The halftoning processor 2017 can convert an image of processing object into the print data, and the printing mechanism 2016 performs the printing by acquiring the print data from the halftoning processor 2017.

The above initialization processing is also performed when a print instruction is made on the print instruction screen 2110.

The initialization of the halftoning processor 2017 is omitted if the latest initializing condition information is identical to the previous initializing condition information, so that the load of the CPU mounted on the printer 2001 is relieved. Also, since the initialization is performed before the print start button SB is pressed, there is no drawback that it takes a long time period since the print start button SB is pressed till the first print is performed.

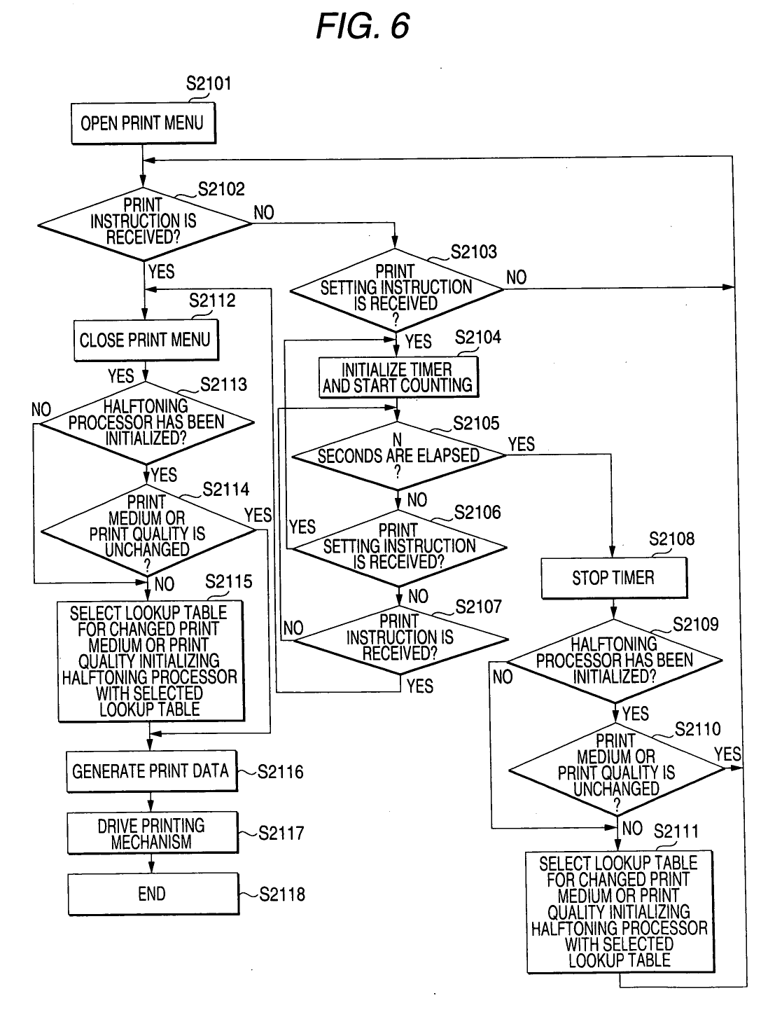

Referring to a flowchart of FIG. 6, a print processing executed by the printer 2001 will be described below.

First, a print menu (the initial screen is the print instruction screen 2110) is opened (S2101), and it is determined whether or not there is any print instruction, namely, the print start button SB is pressed (S2102). If there is any print instruction at S2102, the print menu (print instruction screen 2110) is closed (S2112: the print menu is not necessarily closed), and the processing is passed to S2113. The processing following S2113 (S2112 to S2118) will be described later.

If there is no print instruction at S2102 (“No” at S2102), it is determined whether or not the print medium type A and/or print quality B is newly set (S2103). If the print medium type A and/or print quality B is not newly set (“No” at S2103), the processing is returned to S2102. If the print medium type A and/or print quality B is newly set at S2103 (“Yes” at S2103), the time counter 2013 is initialized to start the time count (S2104). Then, it is determined whether or not the time counter 2013 counts N seconds (N seconds pass from the setting of the print medium type A or the print quality B) (S2105). If N seconds are not counted (“No” at S2105), it is determined whether or not the print medium type A and/or print quality B is newly set (S2106).

If the print medium type A and/or print quality B are newly set at S2106 (“Yes” at S2106), the processing is returned to S2104. Thereby, the time counter 2013 (timer) is initialized again, and the time count is started (S2104). If the print medium type A and/or print quality B is not newly set at S2106 (“No” at S2106), it is determined whether or not there is any print instruction (S2107). If there is no print instruction at S2107 (“No” at S2107), the processing is returned to S2105. In this case, the time counter 2013 is not initialized but continues to count the time. If there is any print instruction at S2107 (“Yes” at S2107), the processing is passed to S2112, whereby the halftoning processor 2017 is initialized directly as will be described later.

If the time counter 2013 counts N seconds at S2105 (“Yes” at S2105), the time count is finished (S2108).

Thereafter, it is determined whether or not the halftoning processor 2017 is initialized (S2109). If it is determined that the halftoning processor 2017 is initialized at S2109 (“Yes” at S2109), it is determined whether or not the settings of the print medium type A and/or print quality B are identical to the settings stored in the print setting information storage 2012 (i.e., the print medium type A and/or print quality B at the previous initialization of the halftoning processor 2017) (S2110). If it is determined that the settings of the print medium type A and/or print quality B are not identical to the settings stored in the print setting information storage at S2110 (“No” at S2110), and if it is determined that the halftoning processor 2017 is not initialized at S2109 (“No” at S2109), the LUT corresponding to the settings of the print medium type A and/or print quality B is selected, the halftoning processor 2017 is initialized (S2111), and the processing is returned to S2102 to determine whether or not there is any print instruction. If it is determined that the settings of the print medium type A and/or print quality B are identical to the settings stored in the print setting information storage 2012 at S2110 (“Yes” at S2110), the processing is returned to S2102 to determine whether or not there is any print instruction.

If it is determined that there is any print instruction at S2102 (“Yes” at S2102), the processing is returned to S2112 to close the print instruction screen 2110, as previously described. When the print instruction screen 2110 is closed, it is determined whether or not the halftoning processor 2017 is already initialized (S2113). If the halftoning processor 2017 is already initialized at S2113 (“Yes” at S2113), it is determined whether or not the settings of the print medium type A and/or print quality B are identical to the settings stored in the print setting information storage 2012 (i.e., the print medium type A and/or print quality B at the previous initialization of the halftoning processor 2017) (S2114). If the settings of the print medium type A and/or print quality B are not identical to the settings stored in the print setting information storage 2012 at S2114 (“No” at S2114), and if the halftoning processor 2017 is not initialized at S2113 (“No” at S2113), the LUT corresponding to the settings of the print medium type A and/or print quality B is selected, the halftoning processor 2017 is initialized (S2115), and the processing is passed to the print data generation (S2116). If the settings of the print medium type A and/or print quality B are identical to the settings stored in the print setting information storage 2012 at S2114 (“Yes” at S2114), the processing is also passed to the print data generation (S2116).

Thereafter, the printer unit (printing mechanism) 2016 is driven (S2117), and after the printing is performed, the processing is finished (S2118).

If the value of N is too small, when one of the print medium type A and the print quality B is newly set, the halftoning processor 2017 is initialized while the user tries to newly set the other, whereby the processing is returned to S2102. Accordingly, when the user sets the print medium type A or the print quality B, the halftoning processor 2017 must be initialized again (see S2105). Also, if the value of N is too large, when a print instruction is made (the print start button SB is pressed) (see “Yes” at S2107) before starting the initialization of the halftoning processor 2017, the initialization of the halftoning processor 2017 is started based on the print instruction (see S2115), whereby the effects of this embodiment can not be attained. Accordingly, the value of N is decided in view of the above circumstances.

A sub-program for performing the processing (especially from S2102 to S2115) as shown in the flowchart of FIG. 6 constitutes a print data generator initialization program for the printer.

Next, a third embodiment of the invention will be described. In this embodiment, when a screen on the display transits from a lower hierarchy where the print setting information is set to an upper hierarchy where the print instruction is made, the halftoning processor (print data generator) is initialized.

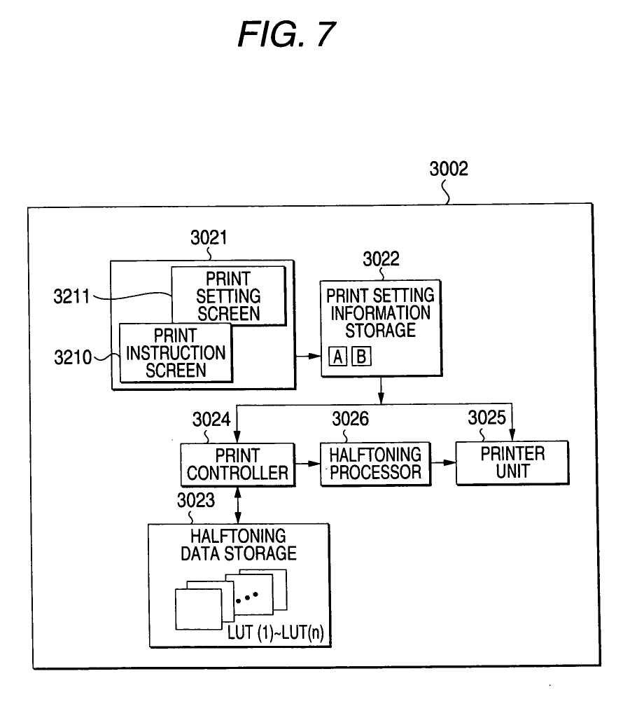

As shown in FIG. 7, a printer 3002 comprises a display 3021, a print setting information storage 3022, a halftoning data storage (print data generation table group storage) 3023, a print controller 3024, a printer unit (printing mechanism) 3025, and a halftoning processor (print data generator) 3026.

In the display 3021, a print instruction screen 3210 is displayed as the initial screen, as shown in FIG. 5. A print setting button PS as described in the second embodiment is displayed on the print instruction screen 3210. By pressing this print setting button PS, the screen display is changed to a print setting screen 3211 on the lower hierarchy. The print setting screen 3211 includes the text boxes for a plurality of print setting information. In this embodiment, like the second embodiment, the print setting information is print medium type A and print quality B, and the print setting screen 3211 contains the text boxes a, b for them.

The print setting information storage 3022 stores the print medium type A and the print quality B used at the previous initialization of the halftoning processor 3026. In this embodiment, like the second embodiment, the previous initializing condition information of the halftoning processor 3026 is the print medium type A and the print quality B used at the previous initialization of the halftoning processor 3026, but may be the information (e.g., table ID) specifying a print data generation table used at the previous initialization of the halftoning processor 3026.

The halftoning data storage 3023 stores a group of lookup tables (LUT(1) to LUT(n): halftoning data) corresponding to a plurality of print medium types A and a plurality of print qualities B.

The print controller 3024 performs the following processing, when the display on the display 3021 transits from the print setting screen 3211 (lower hierarchy) to the print instruction screen 3210 (upper hierarchy), if at least one of the print medium type A and the print quality B is set.

That is, the initialization of the halftoning processor 3026 is already performed, and it is determined whether or not the print medium type A and/or the print quality B that are newly set are identical to the print medium type A and/or the print quality B used at the previous initialization of the halftoning processor 3026, in which if identical, the initialization of the halftoning processor 3026 is not performed, or if not identical, the initialization of the halftoning processor 3026 is performed.

This initialization is performed based on the lookup table corresponding to the latest print medium type A and/or print quality B. That is, the print controller 3024 initializes the halftoning processor 3026 by referring to the lookup table corresponding to the setting values of the print medium type A and print quality B from the group of lookup tables (LUT(1) to LUT(n)). The halftoning processor 3026 can convert an image of processing object into the print data, and the printing mechanism 3025 performs the printing by acquiring the print data from the halftoning processor 3026.

The initialization of the halftoning processor 3026 is omitted if the latest initializing condition information is identical to the previous initializing condition information, so that the load of the CPU mounted on the printer 3002 is relieved. Also, since the initialization is performed before the print start button SB is pressed, there is no drawback that it takes a long time period since the print start button SB is pressed till the first print is performed.

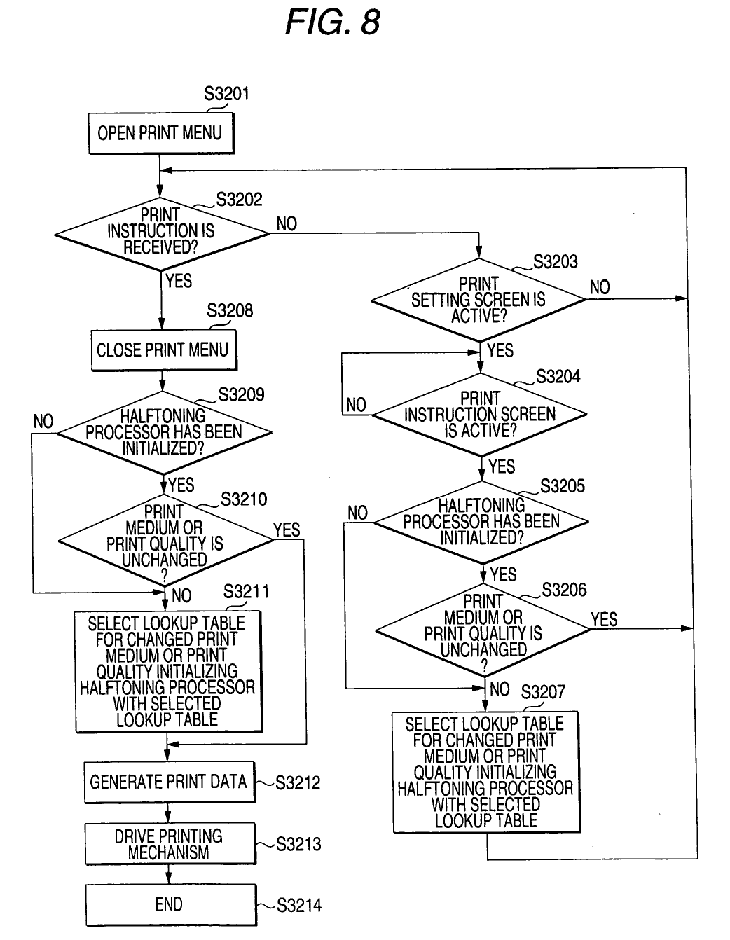

Referring to a flowchart of FIG. 8, a print processing executed by the printer 3002 will be described below.

First, the print instruction screen 3210 is opened (S3201), and it is determined whether or not there is any print instruction, namely, the print start button SB is pressed (S3202). If there is any print instruction at S3202, the print menu (print instruction screen 3210) is closed (S3208: the print menu is not necessarily closed), and the processing is passed to S3209. The processing following S3209 (S3209 to S3214) will be described later.

If there is no print instruction at S3202 (“No” at S3202), it is determined whether or not the processing transits to the print setting screen 3211 (S3203). If the processing does not transit to the print setting screen 3211 (“No” at S3203), the processing is returned to S3202. If the processing transits to the print setting screen 3211 at S3203 (“Yes” at S3203), it is determined whether or not the processing returns to the print instruction screen 3210 (S3204). If not, the determination is continued (“No” at S3204). If the processing returns to the print instruction screen 3210 at S3204, it is determined whether or not the halftoning processor 3026 is already initialized (S3205). If it is determined that the halftoning processor 3026 is initialized at S3205 (“Yes” at S3205), it is determined whether or not the settings of the print medium type A and/or print quality B are identical to the settings stored in the print setting information storage 3022 (i.e., the settings at the previous initialization) (S3206). If it is determined that the settings of the print medium type A and/or print quality B are not identical to the settings stored in the print setting information storage 3022 at S3206 (“No” at S3206), and if it is determined that the halftoning processor 3026 is not initialized at S3205 (“No” at S3205), the LUT corresponding to the settings of the print medium type A and/or print quality B is selected, the halftoning processor 3026 is initialized (S3207), and the processing is returned to S3202 to determine whether or not there is any print instruction. If it is determined that the settings of the print medium type A and/or print quality B are identical to the settings stored in the print setting information storage 3022 at S3206 (“Yes” at S3206), the processing is returned to S3202 to determine whether or not there is any print instruction.

When the print menu (print instruction screen 3210) is closed at S3202, it is determined whether or not the halftoning processor 3026 is already initialized (S3209). If the halftoning processor 3026 is already initialized at S3209 (“Yes” at S3209), it is determined whether or not the set print medium type A and/or print quality B are identical to the print medium type A and/or print quality B stored in the print setting information storage 3022 (S3210). If the settings of the print medium type A and/or print quality B are not identical to the settings stored in the print setting information storage 3022 at S3210 (“No” at S3210), and if the halftoning processor 3026 is not initialized at S3209 (“No” at S3209), the LUT corresponding to the settings of the print medium type A and/or print quality B is selected, the halftoning processor 3026 is initialized (S3211), and the processing is passed to the print data generation (S3212). If the settings of the print medium type A and/or print quality B are identical to the settings stored in the print setting information storage 3022 at S3210 (“Yes” at S3210), the processing is passed to S3212.

Thereafter, the printing mechanism 3025 (printer unit) is driven (S3213), and after the printing is performed, the processing is finished (S3214).

A sub-program for performing the processing (especially from S3202 to S3211) as shown in the flowchart of FIG. 8 constitutes a print data generator initialization program for the printer.

Next, a fourth embodiment of the invention will be described. This embodiment is a combination of the second embodiment and the third embodiment. Namely, when the print medium quality A and/or print quality B are set on the print setting screen, the halftoning processor (print data generator) is initialized if a predetermined time period passes after the setting time, or if the screen on the display transits from a lower hierarchy where the print setting information is set to an upper hierarchy where the print instruction is made.

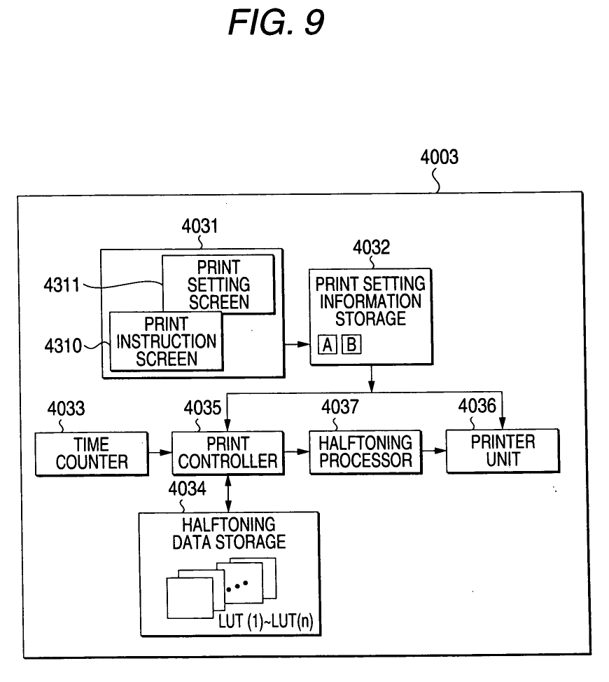

As shown in FIG. 9, a printer 4003 comprises a display 4031, a print setting information storage 4032, a time counter 4033, a halftoning data storage (print data generation table group storage) 4034, a print controller 4035, a printer unit (printing mechanism) 4036, and a halftoning processor (print data generator) 4037.

In the display 4031, a print instruction screen 4310 is displayed as the initial screen, as shown in FIG. 5. A print setting button PS as described in the second and third embodiments is displayed on the print instruction screen 4310. By pressing this print setting button PS, the screen display is changed to a print setting screen 4311 on the lower hierarchy. The print setting screen 4311 includes the text boxes for a plurality of print setting information. In this embodiment, the print setting information is print medium type A and print quality B, and the print setting screen 4311 contains the text boxes a, b for them, as shown in FIG. 5.

The print setting information storage 4032 stores the previous initializing condition information of the halftoning processor 4037. In this embodiment, the previous initializing condition information is the print medium type A and/or the print quality B used at the previous initialization of the halftoning processor 4037, but may be the information (e.g., table ID) specifying a print data generation table used at the previous initialization of the halftoning processor 4037.

The time counter 4033 counts the time from the set time till the elapse of a predetermined time, if at least one of the print medium type A and the print quality B is set on the print setting screen 4311.

The halftoning data storage 4034 stores a group of lookup tables (LUT(1) to LUT(n): halftoning data) corresponding to a plurality of print medium types A and a plurality of print qualities B.

The print controller 4035 performs: (i) the initialization of the halftoning processor 4037 based on the lookup table (any of LUT(1) to LUT(n)) corresponding to the latest print medium type A and/or print quality B, when the count value of the time counter 4033 indicates the elapse of the predetermined time; and (ii) the initialization of the halftoning processor 4037 based on the lookup table (any of LUT(1) to LUT(n)) corresponding to the latest print medium type A and/or print quality B, when the display screen transits from the hierarchy of the print setting screen for the print medium type A and/or print quality B to the hierarchy of the print instruction screen where the print instruction is made, if at least one of the print medium type A and the print quality B is newly set on the print setting screen.

The print controller 4035 does not newly perform the initialization of the halftoning processor, if the latest settings of the print medium type A and/or print quality B are identical to the settings of the print medium type A and/or print quality B at the previous initialization of the halftoning processor 4037, and if the halftoning processor 4037 is already initialized based on the lookup table corresponding to the print medium type A and/or print quality B, when the print instruction is made. Thereby, the load of the CPU mounted on the printer 4003 is relieved, and there is no drawback that it takes a long time period since the print start button SB is pressed till the first print is performed.

The print controller 4035 performs the following processing, when the count value of the time counter 4033 indicates the elapse of predetermined time, or when the display on the display transits from the print setting screen 4311 at the lower hierarchy to the print instruction screen 4310 at the upper hierarchy, if at least one of the print medium type A and the print quality B is set on the print setting screen 4311.

That is, the initialization of the halftoning processor 4037 is already performed, and it is determined whether or not the print medium type A and/or the print quality B that are newly set are identical to the print medium type A and/or the print quality B used at the previous initialization of the halftoning processor 4037, in which if identical, the initialization of the halftoning processor 4037 is not performed, or if not identical, the initialization of the halftoning processor 4037 is performed.

This initialization is performed based on the lookup table corresponding to the latest print medium type A and/or print quality B. That is, the print controller 4035 initializes the halftoning processor 4037 by referring to the lookup table corresponding to the setting values of the print medium type A and print quality B from the group of lookup tables (LUT(1) to LUT(n)). The halftoning processor 4037 can convert an image of processing object into the print data, and the printing mechanism 4036 performs the printing by acquiring the print data from the halftoning processor 4037.

In the printer 4003 of FIG. 9, if the user sets the print medium type A and/or print quality B, the halftoning processor 4037 is automatically initialized, and when the display returns to the screen at the upper hierarchy where the print instruction is made after the user sets the print medium type A and/or print quality B on the screen at the lower hierarchy, the halftoning processor 4037 is also automatically initialized.

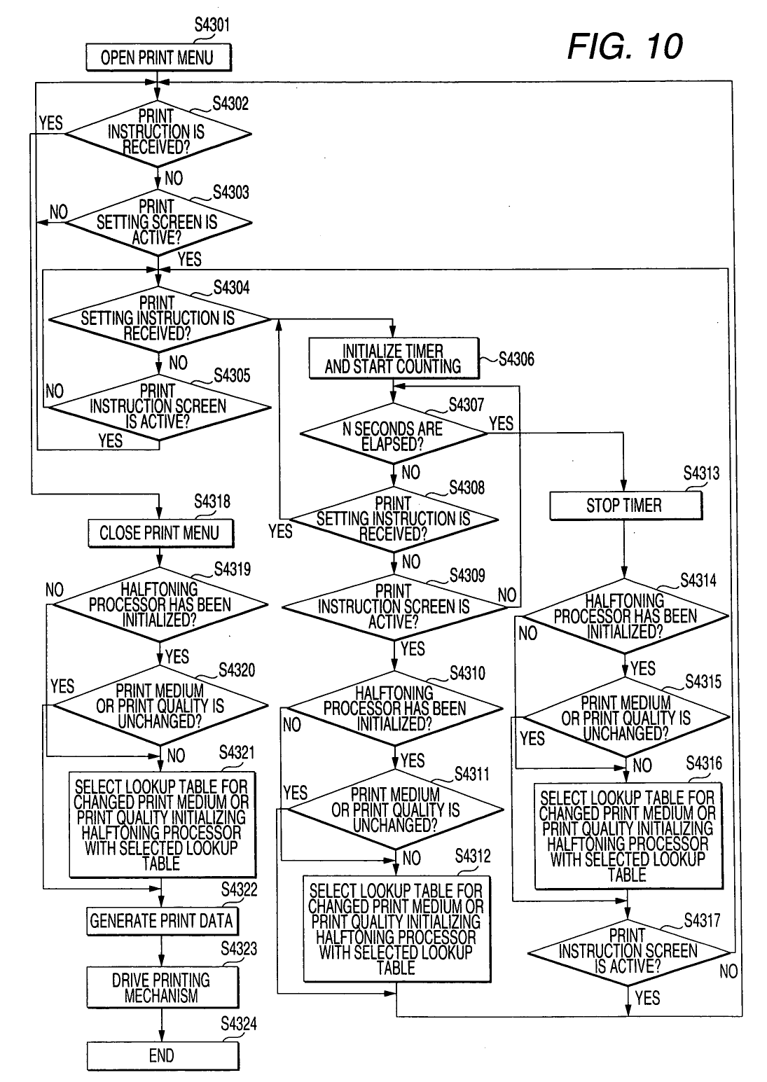

Referring to a flowchart of FIG. 10, a print processing executed by the printer 4003 will be described below.

First, a print instruction screen 4310 is opened (S4301), and it is determined whether or not there is any print instruction, namely, the print start button SB is pressed (S4302). If there is any print instruction at S4302, the print menu (print instruction screen 4310) is closed (S4318: the print menu is not necessarily closed), and the processing is passed to S4319. The processing following S4319 (S4319 to S4324) will be described later.

If there is no print instruction at S4302 (“No” at S4302), it is determined whether or not the display transits to the print setting screen 4311 for the print medium type A and/or print quality B (S4303). If the display does not transit to the print setting screen (“No” at S4303), the processing is returned to S4302. If the display transits to the print setting screen 4311 at S4303 (“Yes” at S4303), it is determined whether or not the print medium type A and/or print quality B are set (S4304). If the print medium type A and/or print quality B are not set (“No” at S4304), it is determined whether or not the display returns to the print instruction screen 4310 (S4305). If the display returns to the print instruction screen 4310 at S4305 (“Yes” at S4305), the processing is returned to S4302, or if the display does not return to the print instruction screen 4310 (“No” at S4305), the processing is returned to S4304.

If the print medium type A and/or print quality B are set at S4304 (“Yes” at S4304), the time counter 4033 (timer) is initialized to start the time count is started (S4306). Then, it is determined whether or not the time counter 4033 counts N seconds (N seconds pass from the setting) (S4307). If N seconds are not counted (“No” at S4307), it is determined whether or not the print medium type A and/or print quality B are set (S4308). If the print medium type A and/or print quality B are set at S4308 (“Yes” at S4308), the processing is returned to S4306. Thereby, the time counter 4033 (timer) is initialized again, and the time count is started. If the print medium type A and/or print quality B are not set at S4308 (“No” at S4308), it is determined whether or not the display returns to the print instruction screen 4310 (S4309). If the display does not return to the print instruction screen 4310 (“No” at S4309), the processing is returned to S4307. In this case, the time counter 4033 is not initialized but continues to count the time.

If the display returns to the print instruction screen 4310 at S4309 (“Yes” at S4309), the processing is passed to S4310 to determine whether or not the halftoning processor 4037 is already initialized (S4310). If it is determined that the halftoning processor 4037 is already initialized at S4310 (“Yes” at S4310), it is determined whether or not the settings of the print medium type A and/or print quality B are identical to the settings stored in the print setting information storage 4032 (i.e., the settings at the previous initialization of the halftoning processor 4037) (S4311). If it is determined that the settings of the print medium type A and/or print quality B are not identical to the settings stored in the print setting information storage 4032 (“No” at S4311), and if it is determined that the halftoning processor 4037 is not initialized at S4310 (“No” at S4310), the LUT corresponding to the settings of the print medium type A and/or print quality B is selected, the halftoning processor 4037 is initialized (S4312), and the processing is returned to S4302 to determine whether or not there is any print instruction. If it is determined that the settings of the print medium type A and/or print quality B are identical to the settings stored in the print setting information storage 4032 at S4311 (“Yes” at S4311), the processing is returned to S4302 to determine whether or not there is any print instruction.

If the time counter 4033 counts N seconds at S4307 (“Yes” at S4307), the time count is finished (S4313).

Thereafter, it is determined whether or not the halftoning processor 4037 is already initialized (S4314). If it is determined that the halftoning processor 4037 is already initialized at S4314 (“Yes” at S4314), it is determined whether or not the latest settings of the print medium type A and/or print quality B are identical to the settings of the print medium type A and/or print quality B stored in the print setting information storage 4032 (S4315). If it is determined that the settings of the print medium type A and/or print quality B are not identical to the settings stored in the print setting information storage 4032 at S4315 (“No” at S4315), and if it is determined that the halftoning processor 4037 is not initialized at S4314 (“No” at S4314), the LUT corresponding to the settings of the print medium type A and/or print quality B is selected, the halftoning processor 4037 is initialized (S4316), and it is determined whether or not the display returns to the print instruction screen 4310 (S4317).

If it is determined that the display returns to the print instruction screen 4310 at S4317 (“Yes” at S4317), the processing is returned to S4302 to determine whether or not there is a print instruction. If it is determined that the display does not return to the print instruction screen 4310 (“No” at S4317), the processing is returned to S4304 to determine whether or not the print medium type A and/or print quality B are set.

If it is determined that the settings of the print medium type A and/or print quality B are identical to the settings stored in the print setting information storage 4032 at S4315 (“Yes” at S4315), the processing is returned to S4317 to determine whether or not the display returns to the print instruction screen 4310.

If it is determined that there is any print instruction at S4302 (“Yes” at S4302), the processing is returned to S4318 to close the print instruction screen 4310, as previously described. When the print instruction screen 4310 is closed, it is determined whether or not the halftoning processor 4037 is already initialized (S4319). If the halftoning processor 4037 is already initialized at S4319 (“Yes” at S4319), it is determined whether or not the settings of the print medium type A and/or print quality B are identical to the settings stored in the print setting information storage 4032 (i.e., the settings at the previous time of printing or default settings when the power is turned off at the previous time of printing) (S4320). If the settings of the print medium type A and/or print quality B are not identical to the settings stored in the print setting information storage 4032 at S4302 (“No” at S4320), and if the halftoning processor 4037 is not initialized at S4319 (“No” at S4319), the LUT corresponding to the settings of the print medium type A and/or print quality B is selected, the halftoning processor 4037 is initialized (S4321), and the processing is passed to the print data generation (S4322).

Thereafter, the printing mechanism 4036 (printer unit) is driven (S4323), and after the printing is performed, the processing is finished (S4324).

A sub-program for performing the processing (especially from S4302 to S4321) as shown in the flowchart of FIG. 10 constitutes a print data generator initialization program for the printer.

Although only some exemplary embodiments of the invention have been described in detail above, those skilled in the art will readily appreciated that many modifications are possible in the exemplary embodiments without materially departing from the novel teachings and advantages of the invention. Accordingly, all such modifications are intended to be included within the scope of the invention.

The disclosure of Japanese Patent Applications No. 2005-288727 filed Sep. 30, 2006 and No. 2006-349551 filed Dec. 2, 2006 including specifications, drawings and claims are incorporated herein by reference in their entirety.

What is claimed is:

1. A method of driving a printer which comprises a print data generator operable to convert inputted image data into print data, and a printing mechanism operable to perform, upon receipt of a print instruction, printing an image with respect to a print medium based on the print data, the method comprising:
activating the printer; and
initializing the print data generator automatically, before the print instruction is received.

2. The method as set forth in claim 1, further comprising:
selecting one of lookup tables each of which is associated with at least one of a type of the print medium and a print quality, wherein:
the initializing is performed with the selected one of the lookup tables.

3. The method as set forth in claim 2, wherein:
the selected one of the lookup tables is associated with at least one of a type of the print medium and a print quality which is first effected after the activating.

4. The method as set forth in claim 2, wherein:
the selected one of the lookup tables is associated with at least one of a type of the print medium and a print quality which is prescribed in advance.

5. The method as set forth in claim 2, wherein:
the selected one of the lookup tables is associated with at least one of a type of the print medium and a print quality which is lastly effected by a user.

6. The method as set forth in claim 1, further comprising:
judging whether a further initialization is necessary after the print instruction is received, based on at least one of a type of the print medium and a print quality included in the print instruction.

7. The method as set forth in claim 6, further comprising:
judging that the further initialization is not necessary in a case where the at least one of the type of the print medium and the print quality is identical with one which is prescribed in advance.

8. The method as set forth in claim 7, further comprising:
it is judged that the further initialization is not necessary in a case where the the type of the print medium is identical with a type of print medium which is either a default one or one lastly effected by the user.

9. The method as set forth in claim 7, further comprising:
it is judged that the further initialization is not necessary in a case where the the print quality is identical with a print quality which is either a default one or one lastly effected by the user.

10. A method of driving a printer which comprises a print data generator operable to convert inputted image data into print data, and a printing mechanism operable to perform, upon receipt of a print instruction, printing an image with respect to a print medium based on the print data, the method comprising:
displaying a print setting screen adapted to update a condition of the printing therethrough;
updating the condition through the print setting screen;
counting a prescribed time period when the setting is performed; and
initializing the print data generator based on the updated condition when the prescribed time period is counted.

11. The method as set forth in claim 10, further comprising:
storing the updated condition as initialization data;
judging that a further initialization of the print data generator is not necessary, even when a further updating of the condition is performed, in a case where:
the initializing has been performed at least once; and
the further updated condition is identical with the previously updated condition; or
initialization data corresponding to the further updated condition is identical with the stored initialization data.

12. The method as set forth in claim 10, further comprising:
judging that a further initialization of the print data generator is not necessary, when the print instruction is received, in a case where:
the initializing has been performed at least once; and
the further updated condition is identical with the previously updated condition; or
initialization data corresponding to the further updated condition is identical with the stored initialization data.

13. The method as set forth in claim 10, wherein:
the condition includes at least one of a type of the print medium and a print quality.

14. A method of driving a printer which comprises a print data generator operable to convert inputted image data into print data, and a printing mechanism operable to perform, upon receipt of a print instruction, printing an image with respect to a print medium based on the print data, the method comprising:
displaying a first screen adapted to input the print instruction therethrough;
displaying a second screen adapted to update a condition of the printing therethrough, and having a lower hierarchy than the first screen;
updating the condition through the print setting screen;
detecting a transition from the second screen to the first screen after the updating is performed; and
initializing the print data generator based on the updated condition when the transition is detected.

15. The method as set forth in claim 14, further comprising:
storing the updated condition as initialization data;
judging that a further initialization of the print data generator is not necessary, even when a further updating of the condition is performed, in a case where:
the initializing has been performed at least once; and
the further updated condition is identical with the previously updated condition; or
initialization data corresponding to the further updated condition is identical with the stored initialization data.

16. The method as set forth in claim 14, further comprising:
judging that a further initialization of the print data generator is not necessary, when the print instruction is received, in a case where:
the initializing has been performed at least once; and
the further updated condition is identical with the previously updated condition; or
initialization data corresponding to the further updated condition is identical with the stored initialization data.

17. The method as set forth in claim 14, wherein:
the condition includes at least one of a type of the print medium and a print quality.
